(19) United States
(12) Patent Application Publication
(10) Pub. No.: US 2017/0210149 A1
(43) Pub. Date: Jul. 27, 2017

(54) LINERLESS LABEL IMAGING AND CUTTING

(71) Applicant: DATALASE LIMITED, Cheshire (GB)

(72) Inventors: Chris Wyres, Cheshire (GB); Tristan Phillips, Cheshire (GB)

(21) Appl. No.: 15/304,417

(22) PCT Filed: Apr. 14, 2014
(86) PCT No.: PCT/GB2015/051131

§ 371 Date: Oct. 14, 2016

(30) Foreign Application Priority Data
Apr. 16, 2014 (GB) 1406854.8
Jul. 31, 2014 (GB) 1413589.1

(51) Int. Cl. B41J 11/70; B41J 3/407

(52) U.S. Cl. CPC B41J 11/70; B41J 3/4075

(57) ABSTRACT

A method and apparatus for imaging, cutting and applying a linerless label substrate 2. The substrate 2 is transported to an imaging area and is selectively illuminated by a suitable laser to form an image. By determining the position of the edge of the image, further laser illumination is used to cut the label substrate thereby providing a single label for application to an object. In this manner, the method of the present invention provides all the benefits of a linerless labelling system plus enables flexibility in printing labels of different sizes.

### TECHNICAL FIELD OF THE INVENTION

The present invention relates to a label printing and cutting, in particular to a method and apparatus for printing and cutting linerless labels. Most particularly, the method and apparatus are provided with one or more lasers operable to generate images in or on the label using a colour change technology and one or more lasers operable to cut or perforate the label.

### BACKGROUND TO THE INVENTION

Inkless printing of labels is an alternative to traditional label printing techniques such as inkjet or thermal transfer where a pigment is applied to a label substrate. The inkless method utilises a substrate whose physical properties (in particular its colour) can be altered upon irradiation with patterns of radiation.

Label application methods and apparatus are well known in the packaging industry. Typically, many label application methods operate using pre-cut labels supported on a backing liner. Each label may be printed with an identical design or may have regions printed with variable information. The labels and backing liner are rewound after printing onto a reel. The reel can be fitted to a label applicator so as to draw forward a continuous strip of liner and labels. The labels are then separated from the liner and applied to an object (typically a package, case, box, carton or product). One example of such labels is marketed by Macsa id wherein pre-cut labels are provided on a backing liner and a CO2 laser is used to form an image on the labels.

Typically, the pre-cut labels in such systems are backed with an adhesive such that they will adhere to the object. As an alternative, U.S. Pat. No. 7,021,549 discloses a heat transfer label system. In this system pre-cut labels supported on a backing liner are applied to the object via a thermal transfer process.

The above techniques all have the disadvantages the backing liner is waste and needs to be disposed of or recycled. Additionally, the backing liner adds thickness, which limits the number of labels that can be provided on a reel for use in a labelling apparatus. Furthermore, use of pre-cut labels requires an additional level of complexity in manufacturing since the labels must be cut after formation on the backing liner.

In view of the above issues, efforts have been made to develop linerless labels. U.S. Pat. No. 7,125,824 discloses linerless label substrate provided with a pressure adhesive layer on one side and a thermally sensitive layer on the other side. The thermally sensitive layer is further covered by a release layer. The release layer has a low adherence to the pressure sensitive adhesive layer, thus allowing the label to be wound on to a reel and subsequently released and applied to an object without use of a backing liner. In this particular example, the thermally sensitive layer allows image markings to be formed on the label by selective application of heat. As an alternative to a release layer, WO2013/082101 discloses a label substrate provided with an adhesive that can be activated. Whilst this does allow the elimination of the release layer it adds more complexity to the application process. Furthermore, this activation generally results in slower application of labels and a consequently reduced product throughput.

In order to apply individual labels printed on a continuous strip of label substrate to a succession of objects, it is necessary to cut the label substrate. One well known technique is to use a mechanical blade to cut the substrate. This has the disadvantage that the blade wears over extended use and must be replaced. Additionally, the blade accumulates debris and adhesive during use and thus requires regular cleaning.

In order to avoid the use of mechanical blades attempts have been made to provide preformed perforations into label substrate. With this approach, it is not possible to adjust the length of label at the point of application even if the size of the imaged region can be modified by the printing or imaging system. Moreover, variation in tension applied to the label substrate (or indeed variations in the perforations) can cause premature tearing of the perforations, particularly when the strip of label substrate is rewound during the manufacturing process. It is therefore necessary to implement the rewind process at a significantly lower tension than normal which leads to a larger diameter reel for a given length of label substrate. Typically, the reduction in tension during rewind leads to a reel diameter that is not significantly smaller than a reel of labels on a backing liner. Therefore any benefit of removing a liner from the label with regard to increasing in the interval to reload the machine is lost.

In order to ensure linerless labels are cut at the correct location, registration marks are provided on the labels at the appropriate cutting points before printing. If the labels are not registered then the cut location may drift with time in relation to the image being printed. In a first implementation, the registration marks comprise marks printed on the rear adhesive side of the label. In a second implementation, the registration marks comprise indentations in the edge of the label substrate. The registration marks are detected by suitable sensors. During the printing process, this registration ensures that the cut locations do not drift with time in relation to the image being printed. During the cutting process, detection of the registration marks triggers the cutting of the label. The provision of registration marks requires additional manufacturing steps ahead of printing increasing the complexity and cost of label manufacture. Moreover, because the registration marks are pre-printed or pre-cut the label size is fixed.

It is therefore an object of the present invention to provide an improved method and apparatus for printing and cutting linerless labels that at least partially overcomes or alleviates the above problems.

### SUMMARY OF THE INVENTION

According to a first aspect of the present invention there is provided a method of printing and cutting a label for application to a product, the method comprising the steps of: providing a strip of linerless label substrate, the label substrate comprising a colour change layer; selectively exposing a section of the linerless label substrate to laser radiation to induce colour change in the colour change layer and thereby form a printed image; determining the position of the edge of the printed image; and cutting the linerless label substrate using a laser in response to the determined position of the edge of the printed image.

According to a second aspect of the present invention there is provided a label printing and cutting apparatus suitable for use with a strip of linerless label substrate, the label substrate comprising a colour change layer in which a printed image may be formed, the apparatus comprising: a label store for retaining and supplying a strip of label substrate; transport means for transporting label substrate from the store to an imaging area; a position sensor for determining the position of the edge of the printed image; and laser illumination means operable to selectively illuminate the label substrate as it is transported through the imaging area so as to induce colour change in the colour change layer thereby forming the printed image, the laser illumination means further operable to cut the label substrate as it is transported through the imaging area in response to the to the position sensor.

The present invention therefore provides a method and apparatus by which linerless label stock may be printed and cut to provide labels of any suitable size. Furthermore, the present invention enables printing and cutting of both fixed size or variable size labels to take place without drift in the relative positions of the printed image and the cut. The present invention further provides for the labels to be cut to size without the use of a mechanical blade.

The method may include the additional step of applying a cut and printed label to an object. This can be achieved by use of an applicator. The applicator may comprise a roller or brush operable to press the label on to the object.

The transport means may comprise one or more belts or rollers. In a preferred embodiment, the transport means comprises a support belt formed from a material adapted such that it does not bond with the adhesive layer. This can allow the transport means to support the label during selective illumination.

Preferably, the cutting takes place at a cutting region. The cutting region may be beyond the end of the support belt. In this manner, damage is not caused to the support belt during cutting. Alternatively, the cutting region may be provided between one or more belts or rollers. In an alternative embodiment, a shield is provided to protect the transport means during the cutting operation.

The store may comprise a spindle. The spindle may be adapted to retain a reel of label substrate.

In order to selectively illuminate the section of the label substrate, the label may be transported past the laser illumination means substantially continuously or in indexed steps. Additionally, or alternatively, the label substrate may be stopped during selective illumination. This can enable the formation of higher definition images or higher definition sections within images. This is particularly advantageous for printing barcodes within images.

The laser illumination means may comprise a scanning unit operable to direct the generated laser beam onto the substrate for printing and/or cutting. The laser illumination means may comprise separate printing and cutting lasers. More preferably, the laser illumination means comprises a single laser. Alternatively, the laser illumination unit may comprise a laser array or an array of fibres coupled to lasers.

The laser illumination means may have a printing mode and a cutting mode. In one preferred implementation, the laser illumination means may operate at a higher power level in cutting mode than printing mode. In another implementation, the transport speed of the substrate may be reduced during cutting mode. In another implementation, the scan speed of the laser illumination means on the substrate may be reduced during cutting mode. Surprisingly, it has been found that use of a single laser illumination means to print an image and cut the substrate does not result in significant discolouration at the cut edge of the substrate.

The cutting laser may be operable to cut through the full thickness of the substrate or may be operable to cut through only part of the thickness of the substrate. The cutting laser may be operable to cut across the full width of the label substrate. Alternatively, the cutting laser may be operable so as to cut part way across the width of the label substrate and/or to cut a series of perforations across the full width of the label substrate. In order to cut a series of perforations, the cutting laser may be operable in a pulsed mode.

The laser illumination means may have an operating wavelength in the range 200 nm to 20 μm. In particular, the laser illumination means may have an operating wave band in any one or more of the following regions: 200-350 nm; 350-400 nm; 390-450 nm; 400-410 nm; 410-450 nm; 450-700 nm; 800-1000 nm; 1-5 μm, or 9-11 μm.

In particular, the laser illumination means may be a CO2 laser. Surprisingly, it has been found that a CO2 laser enables the formation of clear images through a release layer. In such embodiments, the operating waveband of the CO2 laser may be in the standard operating region at substantially 10.6 μm. More preferably, the operating waveband of the CO2 laser may be in the P or R sub branches at substantially 9.4 μm or 10.4 μm

The position sensor may comprise an optical sensor. The optical sensor may be operable to determine the location of the edge of the image. The determination may be achieved by: directly detecting an edge of the image; or by detecting a registration mark identifying the edge of the image. The registration mark may comprise a printed mark or an indentation. The printed mark may be formed alongside the printed image by the laser illumination means. The indentation may be formed alongside the printed image by the laser illumination means. Alternatively, the position sensor may comprise a transport sensor monitoring operation of the transport means. The transport sensor may be operable to determine, based on the size of the printed image and the operation of the transport means, the location of the edge of the printed image.

The substrate may comprise a base layer having an adhesive layer provided on one side and colour change layer covered by a release layer on the other side. Alternatively, the substrate may comprise a base layer having a release layer provided on one side and colour change layer covered by an adhesive layer on the other side. The base layer may comprise paper or a polymeric film. Suitable polymeric films include but are not limited to polypropylene or polyethylene. Where the base layer is paper, the colour change layer may be omitted and the paper may be impregnated with a colour change material.

An NIR (near infra red) absorber may be added to the base layer and/or the colour change layer. The absorber may facilitate the transfer of energy from an NIR laser illumination means to the colour change layer. Additionally, the absorber may facilitate the transfer of energy from an NIR laser illumination means to the substrate reducing the laser fluence required for cutting. Suitable NIR laser illumination means include, but are not limited to: fibre or diode lasers with scanning systems, arrays of lasers, arrays of fibre coupled lasers or arrays of fibre lasers.

The colour change layer may comprise a metal oxyanion, a leuco dye, a diacetylene, a charge transfer agent or a diacetylene. The metal oxyanion may be a molybdate. In particular, the molybdate may be ammonium octamolybdate. The colour change layer may further comprise an acid generating agent. The acid generating agent may be an amine salt of an organoboron or an organosilicon complex. In particular, the amine salt of an organoboron or an organosilicon complex may be tributylammonium borodisalicylate.

The adhesive layer may comprise any suitable adhesives including, but not limited to: pressure-sensitive adhesives (PSA), activatable adhesives, hot melt adhesives. Preferably, the adhesive is a pressure sensitive adhesive, such as an acrylic based adhesive or a natural or synthetic rubber containing elastomer. The adhesive layer may additionally comprise: a plasticizer, a tackifier, and an adhesive base polymer. The adhesive base polymer may include, but is not limited to: butyl acrylate, styrene, methyl methacrylate, methacrylic acid, and acrylic acid. The adhesive may be transparent or opaque or any degree in between.

The release layer may be: silicone based; non-silicone based; or a mixture thereof. Suitable silicone based release layers include, but are not limited to: vinyl silicones. Examples of silicone release agents include the Syl-off® range supplied by Dow Corning. Suitable non-silicone release layers include, but are not limited to: waxes and non-waxes, polyethylene, ethoxylated alcohols, alkyd polymers, polyvinyl alkyl carbamates. The release layer may be: solventless, solvent-based, emulsion, heat-curable or UV-curable. The release layer may be transparent to laser radiation or may have a small level of laser radiation absorption. If the release layer does have a small level of laser absorption, this can assist in image formation.

According to a third aspect of the present invention there is provided a linerless label substrate suitable for use in the label printing and cutting method of the first aspect of the present invention or with the label printing and cutting apparatus of the second aspect of the present invention, the substrate comprising: a base layer having an adhesive layer provided on one side and colour change layer covered by a release layer on the other side.

The substrate of the third aspect of the present invention may incorporate any or all features of the first and second aspects of the present invention as desired or as required.

According to a fourth aspect of the present invention there is provided a linerless label substrate suitable for use in the label printing and cutting method of the first aspect of the present invention or with the label printing and cutting apparatus of the second aspect of the present invention, the substrate comprising: a base layer having a release layer provided on one side and colour change layer covered by an adhesive layer on the other side.

The substrate of the fourth aspect of the present invention may incorporate any or all features of the first and second aspects of the present invention as desired or as required.

### DETAILED DESCRIPTION OF THE INVENTION

In order that the invention may be more clearly understood an embodiment thereof will now be described, by way of example only, with reference to the accompanying drawings, of which:

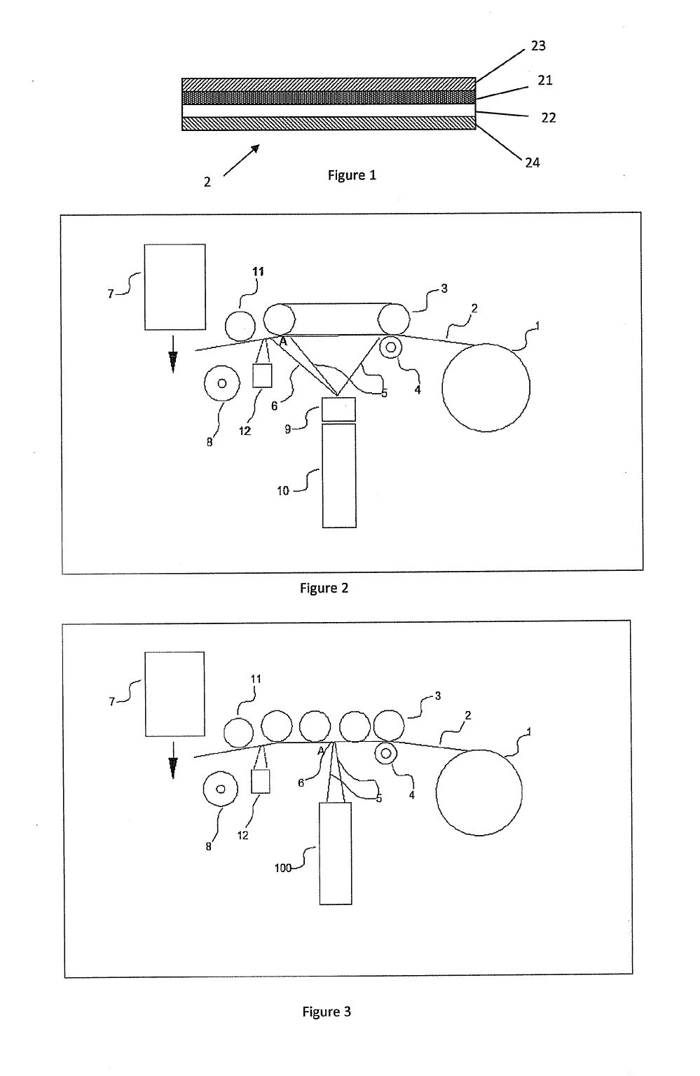

FIG. 1 is a schematic illustration of a linerless label substrate for use in the present invention;

FIG. 2 is a schematic illustration of a label printing and cutting apparatus for a linerless label substrate according to the present invention; and

FIG. 32 is a schematic illustration of an alternative embodiment of a label printing and cutting apparatus for a linerless label substrate according to the present invention.

The present invention discloses a method and apparatus for imaging, cutting and applying a label to a package or product. In particular the present invention discloses a method and apparatus for imaging, cutting and applying a linerless label substrate 2 as shown in FIG. 1. The label substrate 2 comprises a base layer 21, a colour change layer 22, an adhesive layer 23, and a release layer 24. The base layer 21 may comprise paper or a polymeric film such as polypropylene. The colour change layer 22 incorporates a colour change compound operable to change colour in response to illumination by light from a suitable laser. The adhesive layer 23 comprises adhesive which allows the label 2 to adhere to an object. The release layer 24 comprises a material adapted to have low adherence to the adhesive layer 23. In this manner, the label substrate 2 may be wound on and dispensed from a reel.

In the method of the present invention, the substrate 2 is transported from a storage reel to an imaging area. At the imaging area, the label substrate 2 is selectively illuminated by a suitable laser to form an image in the colour change layer 22. By determining the position of the edge of the image, further laser illumination may be used to cut the label substrate thereby providing a single label for application to an object. In this manner, the method of the present invention provides all the benefits of a linerless labelling system plus enables flexibility in printing labels of different sizes.

Turning now to FIGS. 2 and 3, apparatus for carrying out the method of the present invention is illustrated schematically. A reel 1 is wound with a strip of label substrate 2, the reel 1 being supported on a spindle (not shown). The label substrate 2 is pulled forward from the reel 1 by a transport means 3 comprising a roller, rollers (FIG. 2) or belt (FIG. 3). A brush 4 is located at the input end of the mechanism 3 and may be used to press the label substrate 2 onto a support belt or rollers 3. The brush 4 improves the uniform contact area and minimizes substrate distortion during illumination. Whilst brush 4 is beneficial, the skilled man will appreciate it is not essential to the operation of the invention. The label substrate 2 is arranged such that the adhesive layer 23 faces the support belt or rollers 3. In order that the support belt or rollers 3 provides sufficient tension to release the substrate 2 from the reel 1 but with low adhesion to the adhesive layer 23, the support belt or rollers 3 may be formed from silicone or other suitable material.

Whilst the label substrate 2 is supported on belt or rollers 3, it is selectively illuminated by a laser 10, within an imaging area 5 defined by scanning unit 9 (FIG. 2). Alternatively, the label substrate 2 is selectively illuminated by a laser array 100, within an imaging area 5 (FIG. 3). As a result of the illumination, an image is formed in the colour change layer 22 of the substrate. In some implementations, the illumination can take place whilst the substrate 2 is being transported. In other embodiments, illumination may take place whilst the substrate 2 is stationary or there may be a combination of moving and stationary illumination. Stationary illumination is particularly favoured with lasers and scanning units for printing bar codes and may be necessary to ensure any bar codes are of sufficient quality to ensure at least grade C, preferably grade B and preferentially grade A. Illumination whilst moving is typically sufficient for other text and/or graphics. A combination of imaging whilst moving for text and static for bar code provides minimum time for imaging with high quality barcodes.

After printing is complete, a cut is made across the substrate 2, so as to separate or provide a weakened region that is allows easy separation of an individual label from the substrate strip 2 for application to an object 7. The cut may completely separate the image from the remainder of the substrate. Alternatively, the cut may extend only partway across the substrate and/or comprise a series of perforations. The cut may also be a groove or channel that extends partway through the substrate.

In order to make the cut, the position of the edge of the printed image is determined. In the apparatus of FIG. 2, the position of the edge of the printed image is detected by optical sensor 12. This sensor can be operable in response to directly detecting the edge of the printed image. More preferably, the sensor 12 is operable to detect a registration mark printed during the selective illumination or an indentation in the substrate cut during illumination. In alternative embodiments it is however possible to monitor the movement of the support belt and use this in combination with knowledge of the size of the printed image to determine the position of the edge of the image.

In order to form a cut, the scan speed of the laser beam 10 is reduced by scanning unit 9 and/or the output power of laser 10 is increased. If a continuous laser beam is used, this results in cut across all or part of the width of the substrate 2. If however a pulsed laser beam is used, a series of perforations may be formed across the width of the substrate 2.

As is shown in FIG. 2, the cut is made in a cutting region A illuminated by beam path 6 at the exit end of the support belt or rollers 3. At this time the label substrate 2 protrudes beyond the end of the support belt or rollers 3 but is still supported by the support belt or rollers 3. Whilst the cutting operation could be performed anywhere within the imaging region 5, it is advantageous to provide the cutting region A beyond the support belt or rollers 3. As a result, undue and/or excessive wear or damage of the support belt or rollers 3 due to the incidence of the laser beam is avoided. The skilled man will however appreciate that similar benefits could be provided by ensuring the cutting region A is aligned with a gap between belts or rollers or if a suitable shield is provided to protect the belt or roller from the laser beam.

In the apparatus of FIG. 3, the position of the edge of the printed image is detected by monitoring the movement of the transport means 3 and using this in combination with knowledge of the size of the printed image to determine the position of the edge of the image. The output power of laser array 10 can then be increased, so as to form a cut. As is shown in FIG. 3, the cut is made in a cutting region A illuminated by beam path 6 between two rollers 3.

After cutting, the label is applied to an object 7 by applicator means. In the present example, the applicator means comprise a support roller 11 and a fixing roller 8 which presses the label onto the object 7. Where the cutting extends only part way through the thickness of the substrate, part way across the substrate or comprises a series of perforations, the apparatus may comprise a further separation means for separating the applied label from the remainder of the substrate. Alternatively, the cut or perforations may be adapted such that the separation occurs as a consequence of the strain on the label during the application process.

In a preferred implementation, the laser 10 is a CO2 laser which has been surprisingly found to enables the formation of clear printed images through release layer 24. Furthermore, the output of a CO2 laser is readily absorbed by the base layer 21 of the substrate 2. As such, the same laser 10 may be used for both imaging and cutting. Surprisingly, it has been found that use of the same laser to print an image and cut the substrate 2 does not result in significant discolouration at the cut edge of the substrate 2.

Typically, the normal CO2 laser wavelength is around 10.6 μm and this is absorbed by many polymeric films and is adequate for cutting. However, this operating wavelength may be tuned for optimum absorption in the base layer 21 as this can reduce the laser fluence required for cutting. In the case of a polypropylene base layer 21, the absorption of polypropylene is significantly higher at 9.3 μm and 10.3 μm than it is at the usual operating wavelength for a CO2 laser (10.6 μm). Accordingly, it is desirable, but not essential, to select an operating wavelength from the so called ‘P’ and ‘R’ vibrational bands of the CO2 molecule at 9.4 μm and 10.4 μm respectively.

The above embodiments are described by way of example only. Many variations are possible without departing from the scope of the invention as defined in the appended claims.

What is claimed is:

1-40. (canceled)

41. A method of printing and cutting a label for application to a product, the method comprising the steps of: providing a strip of linerless label substrate, the label substrate comprising a colour change layer; selectively exposing a section of the linerless label substrate to laser radiation to induce colour change in the colour change layer and thereby form a printed image; determining the position of the edge of the printed image; and cutting the linerless label substrate using a laser in response to the determined position of the edge of the printed image.

42. A method as claimed in claim 41 wherein the method includes the additional step of applying a cut and printed label to an object.

43. A method as claimed in claim 41, wherein the laser illumination operates at a higher power level during cutting.

44. A method as claimed in claim 41 wherein the step of cutting involves cutting through the full thickness of the substrate; or involves cutting through only part of the thickness of the substrate; or involves cutting part way across the width of the label substrate; or involves cutting a series of perforations across the full width of the label substrate.

45. A method as claimed in claim 41 wherein the substrate comprises a base layer having an adhesive layer provided on one side and colour change layer covered by a release layer on the other side or wherein the substrate comprises a base layer having a release layer provided on one side and colour change layer covered by an adhesive layer on the other side.

46. A method as claimed in claim 45 wherein an NIR (near infra red) absorber is added to the base layer and/or the colour change layer.

47. A method as claimed in claim 45 wherein the colour change layer comprises a metal oxyanion, a leuco dye, a diacetylene, a charge transfer agent or a diacetylene.

48. A label printing and cutting apparatus suitable for use with a strip of linerless label substrate, the label substrate comprising a colour change layer in which a printed image may be formed, the apparatus comprising: a label store for retaining and supplying a strip of label substrate; transport means for transporting label substrate from the store to an imaging area; a position sensor for determining the position of the edge of the printed image; and laser illumination means operable to selectively illuminate the label substrate as it is transported through the imaging area so as to induce colour change in the colour change layer thereby forming the printed image, the laser illumination means further operable to cut the label substrate as it is transported through the imaging area in response to the position sensor.

49. A label printing and cutting apparatus as claimed in claim 48 wherein the laser illumination means comprise a laser array or an array of fibres coupled to lasers.

50. A label printing and cutting apparatus as claimed in claim 48 wherein the laser illumination means comprise separate printing and cutting lasers.

51. A label printing and cutting apparatus as claimed in claim 48 wherein the laser illumination means comprises a single laser.

52. A label printing and cutting apparatus as claimed in claim 50 wherein the laser illumination means has a printing mode and a cutting mode and the laser illumination means operates at a higher power level in cutting mode than printing mode.

53. A label printing and cutting apparatus as claimed in claim 52 wherein the laser illumination means is operable, in cutting mode, to: cut through the full thickness of the substrate in cutting mode; or cut through only part of the thickness of the substrate; or cut part way across the width of the label substrate; or cut a series of perforations across the full width of the label substrate.

54. A label printing and cutting apparatus as claimed in claim 48 wherein the laser illumination means has an operating wavelength in the range 200 nm to 20 μm or wherein the laser illumination means has a wavelength in the range 390-450 nm.

55. A label printing and cutting apparatus as claimed in claim 48 wherein the position sensor comprises an optical sensor operable to determine the location of the edge of the image by: directly detecting an edge of the image; or by detecting a registration mark identifying the edge of the image.

56. A label printing and cutting apparatus as claimed in claim 48 wherein the position sensor comprises a transport sensor monitoring operation of the transport means to determine, based on the size of the printed image and the operation of the transport means, the location of the edge of the printed image

57. A label printing and cutting apparatus as claimed in claim 48 wherein the substrate comprises a base layer having an adhesive layer provided on one side and colour change layer covered by a release layer on the other side or wherein the substrate comprises a base layer having a release layer provided on one side and colour change layer covered by an adhesive layer on the other side.

58. A label printing and cutting apparatus as claimed in claim 57 wherein an NIR (near infra red) absorber is added to the base layer and/or the colour change layer.

59. A label printing and cutting apparatus as claimed in claim 57 wherein the colour change layer comprises a metal oxyanion, a leuco dye, a diacetylene, a charge transfer agent or a diacetylene
